(19) United States
(12) Patent Application Publication
(10) Pub. No.: US 2004/0111670 A1
(43) Pub. Date: Jun. 10, 2004

(54) Server and client terminal for presenting device management data of XML data

(75) Inventors: Haruna Sasakuma, Toyonaka-shi (JP); Tomohiro Nishiguchi, Daito-shi (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka-shi (JP)

(21) Appl. No.: 10/421,925

(22) Filed: Apr. 24, 2003

(30) Foreign Application Priority Data
Dec. 6, 2002 (JP) 2002-354806

(51) Int. Cl. G06F 17/00

(52) U.S. Cl. 715/513; 715/522

(57) ABSTRACT

In a network including a device manager, a device and a client terminal, an acquisition device in the device manager acquires device management data from the device and stores the data as XML data. A selector selects a stylesheet used to present the XML data among one or more stylesheets to be accessed through the network, and an editor correlates the XML data with the selected stylesheet. When the XML data is requested through the network by a presenter of the XML data, a data provider provides the XML data stored in the storage device. Alternatively, the stylesheet selection may be performed in the client terminal. The client terminal can download the stylesheet and present the XML data with the stylesheet.

This application is based on application No. 2002-354806 filed in Japan, the contents of which are hereby incorporated by reference.

### BACKGROUND OF THE INVENTION

1. Field of the Invention

The present invention relates to presentation of XML data.

2. Description of Prior Art

EXtensible Markup Language (XML) is a markup language having extended functions. XML itself does not define a layout, and presentation such as browsing and printing of data described in XML or XML data is performed with use of a stylesheet described with a stylesheet language such as eXtensible Stylesheet Language (XSL). The document type definition of XML data includes designation of a stylesheet file. In the stylesheet file, a display/print area, a font name, a character size and the like are designated. The stylesheet language may be XSL Transformations (XSLT) or the like.

XML data may be represented in various ways. For example, an application program such as a web browser which supports XML converts XML data with a stylesheet to HyperText Markup Language (HTML) data and displays the HTML data in a screen.

XML is used in various uses, and it is appropriate for transmitting data through a network. For example, when various devices connected to a network are managed, device management data may be XML data. When the device management data are displayed in a web browser which supports XML, the web browser displays the device management data with reference to a stylesheet.

In XML data, a stylesheet for presenting the XML data is designated therein, and the stylesheet is used when the XML data is presented by a web browser. This means that only one user interface is provided for the XML data. However, the status and environment are different among the devices connected to the network, while those of a web browser in a client terminal are also different in many ways. Therefore, in a system for presenting XML data, it is generally desirable to provide a user interface appropriate for each of the circumstances.

In a contents receiver system disclosed in Japanese Patent laid open Publication 2001-24996, various stylesheeets can be used. XML contents such as broadcasting program information can also be broadcast, besides audio-visual data in a digital satellite data broadcast, multimedia contents and the like. XML documents and stylesheets are stored in a separate memory area in a hard disk or a memory card. One of the XML documents is combined with one of the stylesheets. One stylesheet may be combined with a plurality of XML documents. A broadcasting station designates an appropriate stylesheet to provide broadcasting program information in a layout according to user's need, a display device such as a television set or a portable terminal, or the like. In the contents receiver system, a user can customize the stylesheet applied to an XML document of broadcasting program information by editing source codes of the stylesheet displayed on a screen. In the above-mentioned contents receiver system, when broadcasting program information is displayed, an appropriate stylesheet is designated among the stylesheets according to user's need or the like. However, the designation of the stylesheet is performed not by a user, but by the broadcasting station. Though a user can edit the source codes of the stylesheet to customize the stylesheet (or user interface), this is troublesome for a general user.

### SUMMARY OF THE INVENTION

An object of the present invention is to provide a user interface appropriate for each case when XML data are presented through a network.

In one aspect of the invention, a device manager according to the present invention is connectable to one or more devices and one or more client terminals through a network. In the device manager, an acquisition device acquires device management data from the one or more devices, and a storage device stores the acquired management data as XML data. A selector selects a stylesheet used to present the management data as XML data among one or more stylesheets to be accessed through the network. The selection can be performed according to appropriate selection condition such as information on the devices, the client terminal or the like. Then, an editor correlates the selected stylesheet with the XML data. A data provider such as a web server provides the XML data obtained by the editor through the network to a presenter of the XML data supporting XML in one of the one or more client terminals, when a request of the device management data is accepted through the network from the client terminal. Thus, the client terminal can download the stylesheet and present the XML data with the stylesheet.

In another aspect of the invention, a client terminal in the system comprises a data presenter of the XML data supporting XML. The data presenter such as a web browser requests and receives device management data as XML data through the network to and from the server. A storage device stores the received device management data as XML data, and a selector selects a stylesheet used to present the device management data as XML data among one or more stylesheets to be accessed through the network. The selection can be performed according to appropriate selection condition. Furthermore, an editor correlates the stylesheet selected by the selector with the XML data. Thus, the client terminal can download the stylesheet and present the XML data with the stylesheet.

An advantage of the present invention is that XML data of, for example, device management data can be presented in an appropriate layout by selecting an stylesheet for the XML data.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of a network system in a first embodiment;

FIG. 2 is a diagram of an example of an XML file;

FIG. 3 is a diagram of an example of a stylesheet;

FIG. 4 is a block diagram of a device;

FIG. 5 is a block diagram of a server;

FIG. 6 is a block diagram of a device manager;

FIG. 7 is a block diagram of a personal computer;

FIG. 8 is a flowchart of stylesheet selection;

FIG. 9 is a flowchart of device management according to the first embodiment;

FIG. 10 is a flowchart of presentation of device management information according to the first embodiment;

FIG. 11 is a diagram of a network system in a modified embodiment;

FIG. 12 is a diagram of a network system in a second embodiment;

FIG. 13 is a block diagram of a personal computer;

FIG. 14 is a flowchart of stylesheet selector;

FIG. 15 is a flowchart of device management in a device manager; and

FIG. 16 is a flowchart of presentation of device management information of a personal computer.

### DETAILED DESCRIPTION OF THE PREFERRED EMBODIMENTS

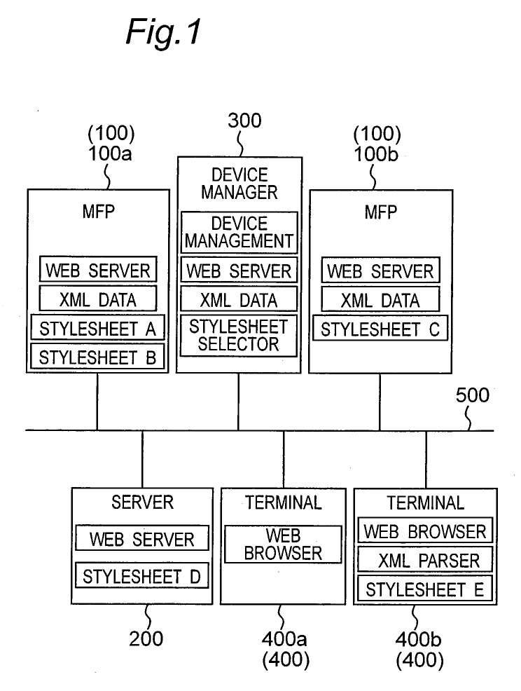

Referring now to the drawings, wherein like reference characters designate like or corresponding parts throughout the several views, FIG. 1 shows a network environment wherein shared devices 100, server apparatuses 200, a device manager 300 and client terminals 400 such as personal computers are connected to a network 500 such as a local area network or the Internet. The shared devices 100 are, for example, a copying machine, a printer, a scanner or a multifunction peripheral (MFP) which can be operated as a copying machine, a printer, a scanner or the like. The server apparatuses 200 include various servers except the device manager 300, which is also a server apparatus, but is represented with a different name for the explanation of this system. The device manager 300 manages one or more devices 100 to be monitored for device management. In this example shown in FIG. 1, the devices 100 include multifunction peripherals 100a and 100b, and the client terminals 400 include terminals 400a and 400b.

In the network environment, the device manager 300 acquires management information from the devices 100 at a predetermined timing, for example, periodically, or when the device management data is requested from a client terminal 400, and makes and stores the device management data in the format of XML data based on the acquired information. As will be explained in detail later, a stylesheet which defines a layout for presenting the XML data is selected among a plurality of stylesheets stored in various components connected to the network 500. The stylesheets are stored in, for example, one or more devices 100, one or more servers 200 and one or more client terminals 400 and the like. In the example shown in FIG. 1, the multifunction peripheral 100a stores two stylesheets “A” and “B”, the multifunction peripheral 100b stores a stylesheet “C”, the server 200 stores a stylesheet “D” and the terminal 400b stores a stylesheet “E”. A stylesheet selector (an application program for executing stylesheet selection) selects an appropriate stylesheet among the stylesheets to present the device management data as XML data, according to selection conditions such as the status and environment of the terminal, those of the device or the like.

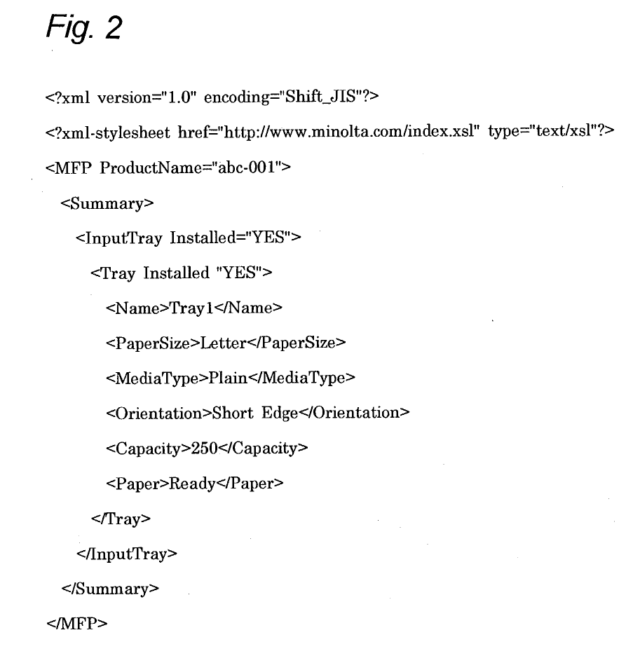

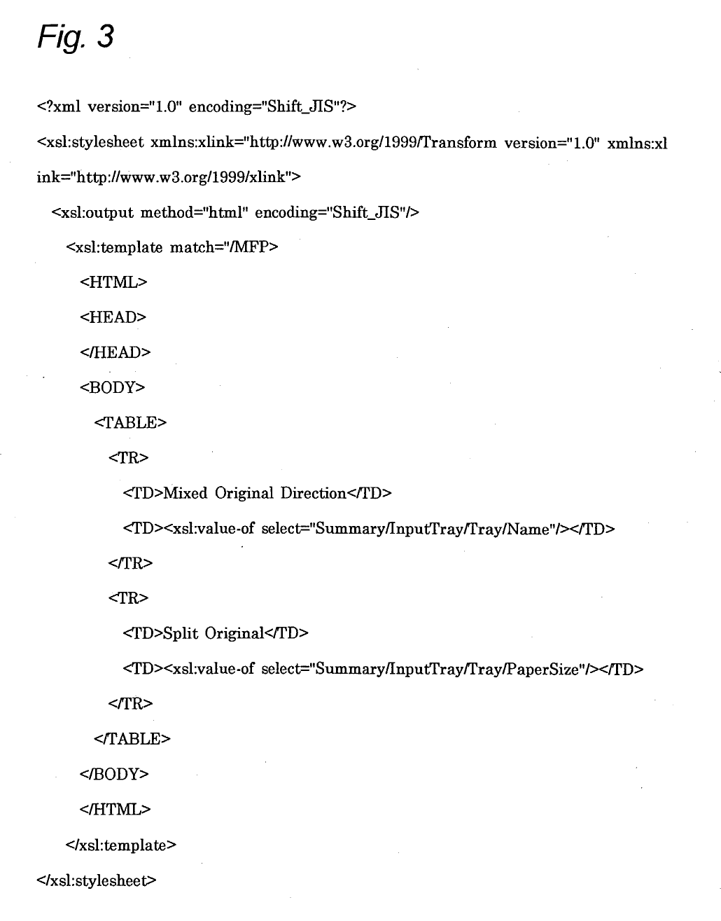

FIG. 2 shows an example of an XML file. In the document type definition in an XML document, a stylesheet for presenting the XML data can be set by designating a stored portion of the stylesheet for the XML data. In this example, in line 2, the position of stylesheet is described after “href=”, and the type of stylesheet is described after “type=”. The management data in this example shows that the model name of the device is “abc-001”, that a document tray is installed, that a paper tray is installed, that the name of the paper tray is “tray 1”, that the paper size is letter, that the medium type of the paper is plain paper, that the transport orientation of the paper is short edge, that the capacity of the paper tray is 250 sheets, and that the paper is set in the paper tray. For the brevity of explanation, only the management data of only one of the devices 100 is shown in FIG. 2. Furthermore, FIG. 3 shows an example of a stylesheet designated in the XML data shown in FIG. 2.

When the device management information is presented, for example, a user at his or her terminal 400 activates an application program such as a web browser which supports XML, sets a uniform resource identifier (URI) of the device manager 300 according to hypertext transfer protocol (HTTP) to request device management information. The web server in the device manager 300 receives the request in HTTP to provide the device management data. For example, the web browser analyzes the XML data and the stylesheet with an XML parser (XML processor) and generates HTML data for browsing, printing or the like. It is to be noted that the communication between the client terminal 400 and the device manager 300 may also use a different protocol such as file transfer protocol (FTP) or the like, but this is not explained here in detail.

Next, the apparatuses 100, 200, 300 and 400 connected to the network 500 are explained.

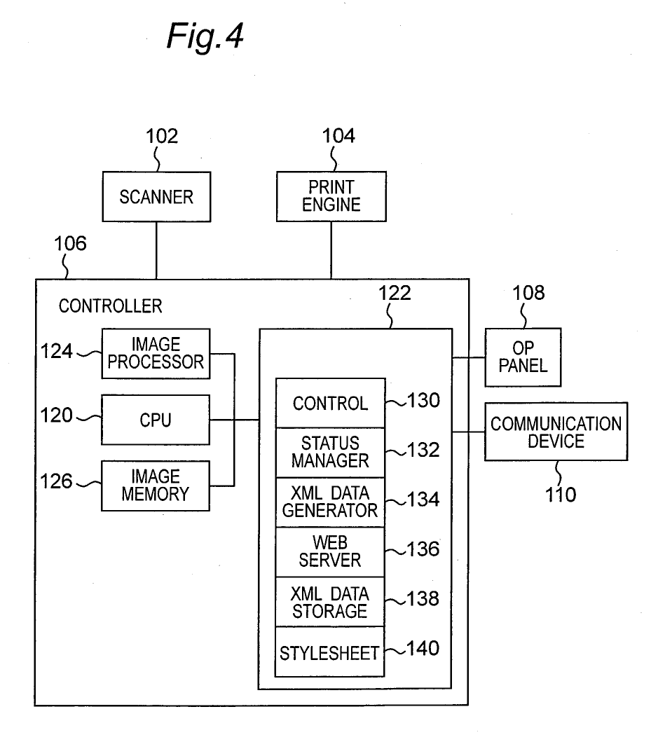

The multifunction peripheral (MFP) 100 as a shared device can be operated as a printer, a scanner or the like. As shown in FIG. 4, it includes a scanner 102 which reads a document image, a print engine 104 which receives print data and prints it on a sheet of paper and a controller 106 which controls the entire multifunction peripheral 100. The controller 106 is connected to an operational panel 108, a communication device 100 including a network interface connectable to the network 400. When print data is received through the communication device 100, raster data is generated, and the print engine 104 is controlled for printing. The controller 106 also generates the management data of the device itself as XML data and sends it to the device manager 300. Furthermore, the multifunction peripheral 100 has a communication device 110 including a network interface to be connected to the network 500.

The controller 106 of the multifunction peripheral 100 has a central processing unit (CPU) 120 which controls the entire device, a storage device 122, an image processor 124, a video memory 126 and the like. The storage device 122 is for example a hard disk drive, and it stores, besides a control program for the multifunction peripheral, programs including a status manager 132 which manages the status of the multifunction peripheral, an XML data generator 234 and a web server 136 for providing XML data, and an XML data storage portion 138 for storing the XML data. Furthermore, the storage device 122 may store one or more stylesheets 140. The status manager 132 collects setting data inputted with the operational panel 108 and signals received from various sensors (not shown) in the device 100. The XML data generator 234 generates the management data acquired by the status manager 132 in the format of XML data, and the XML data storage portion 138 stores the generated XML data. The web server 136 provides the management data when requested from the device manager 300.

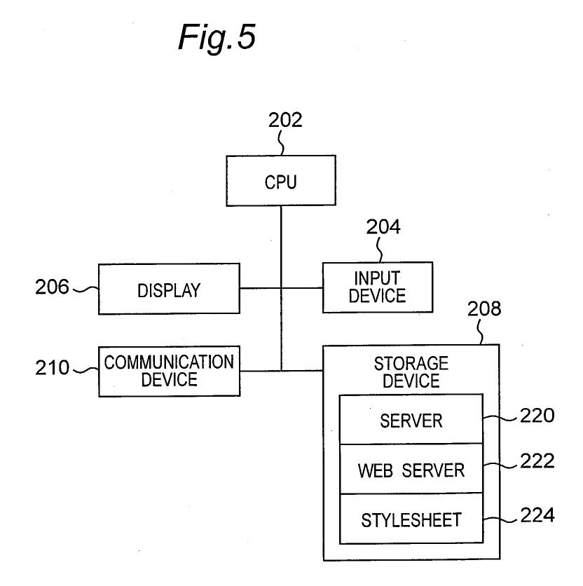

The server 200 is for example a print server, and it has a structure similar to an ordinary computer. As shown in FIG. 5, it has a CPU 202 which controls the entire server 200, an input device 204 such as a keyboard, a display device 206, a storage device 208 such as a hard disk drive, and a communication device 210 including a network interface to be connected to the network 500. The storage device 208 stores, beside an operating system program (not shown), programs such as a print server 220 and a web server 222. Furthermore, it may store one or more stylesheets 224 for XML data.

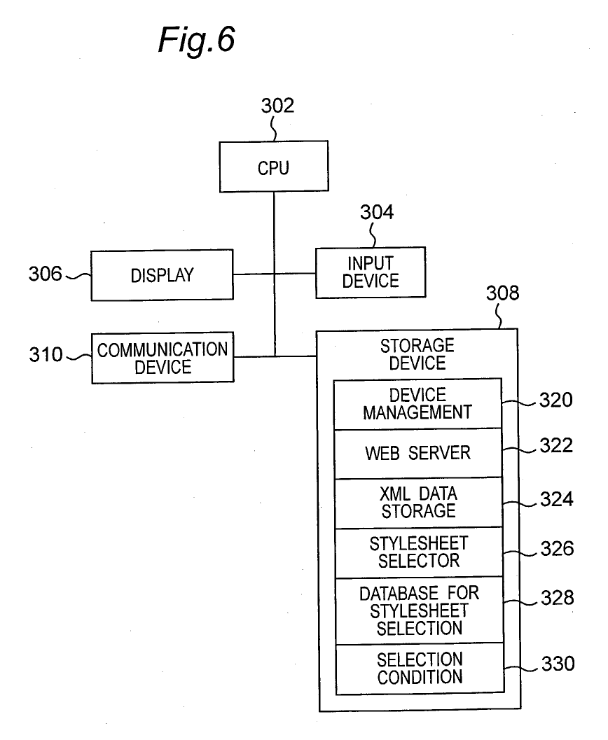

The device manager 300, as shown in FIG. 6, includes a CPU 302 which controls the entire device manager 300, an input device 304 such as a keyboard, a display device 306, a storage device 308 such as a hard disk drive, and a communication device 310 including a network interface to be connected to the network 500, similarly to an ordinary server computer. The storage device 308 stores, beside an operating system program (not shown), programs such as a device management program 320, a web server 322, and a stylesheet selector 326 as an application program in an execution format for selecting a stylesheet, and a storage portion 324 for storing XML data, another storage portion 328 for storing a database for stylesheet selection, and a further storage portion 330 for storing selection condition used for selecting the stylesheet by the stylesheet selector. The device management program 320 acquires management data from devices to be managed thereby connected to the network 500, makes XML data which describes the acquired device management data, and stores it in an XML data storage portion 324. The web server 322 sends the XML data in the XML data storage portion 324 when a request for browsing the device management data is received from the external. The stylesheet selector 326 selects a stylesheet according to the selection condition 330 with reference to the database 328 for the stylesheet selection. The device management program 320 correlates the selected stylesheet to the XML data. That is, it edits the XML data to describe the selected stylesheet in a section for designating the stylesheet for the XML data.

In the device manager 300 explained above, if the storage device 308 is a hard disk drive, programs such as the device management program 320 and the stylesheet selector 326 are stored in a hard disk therein. The programs may also be stored in a medium such as a flexible disk or a compact disk if the storage device 308 is a flexible disk drive or a compact disk drive.

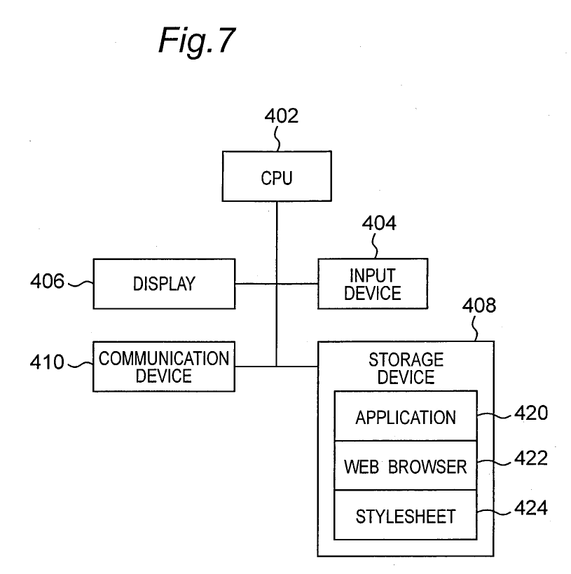

The client terminal 400 is for example a personal computer (PC). For example, as shown in FIG. 7, it has a central processing unit (CPU) 402 which controls the entire terminal 400, an input device 404 such as a keyboard, a display device 406, a storage device 408 such as a hard disk drive, and a communication device 410 including a network interface to be connected to the network 500. The storage device 408 stores, beside an operating system program (not shown) and various application programs 420, an application program 422 for presenting XML data (for example, a web browser which supports XML). Furthermore it may store programs and one or more stylesheets 424 for XML data.

In the device manager 300, a device management program 320 acquires device management data and edits it as XML data. A timing of the acquisition and edition is, for example, when device data is changed, when XML data is requested, a periodic timing, or a predetermined date and time.

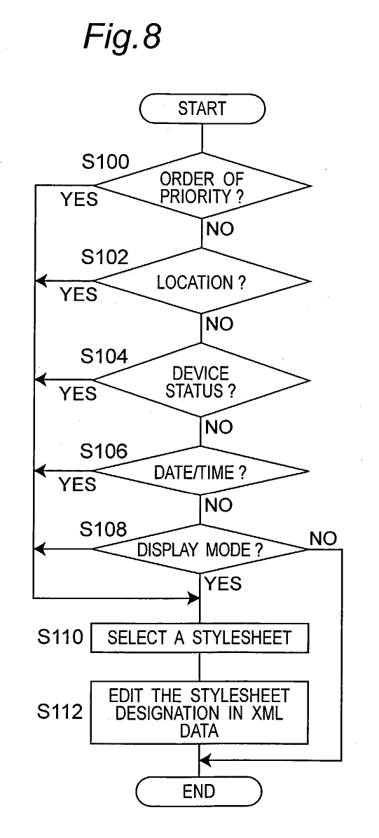

FIG. 8 is a flowchart of stylesheet selection by the stylesheet selector 326. When stylesheet selection is instructed by the device management program 320, stylesheets in the network 500 are retrieved, and a stylesheet is determined according to the selection condition 330 determined beforehand. The selection condition is, for example, status and environment of the device 100, those of the terminal 400 or both, such as the order of priority determined beforehand for each stylesheet, location of the device such as Japan, USA, or the like set in the device, status of the device, date and time such as a maintenance time of the device, or presentation mode set in the device. The data necessary for the selection is stored beforehand in the database 328.

As shown in FIG. 8, when management data of a device is presented, if selection based on the order of priority is instructed (YES at S100), stylesheets available in the network 500 are retrieved, and a stylesheet having the highest priority is selected (S110). If selection based on the location set in the device is instructed (YES at S102), a stylesheet is selected according to a language used at the location (S110). If selection based on the status of the device 100 is instructed (YES at S104), a stylesheet is determined according to the status (S110). For example, if the status includes information desirable to be noticed to the user, a stylesheet suited to noticeably represent the information on the status is selected. For example, when a serious error for the device not to operate normally happens, a screen different from a normal one, for example, including the position of a service man is displayed. If selection based on the date and time is instructed (YES at S106), a stylesheet is selected based on the date ant time (S110) For example, if the date and time is appropriate to advise the maintenance time to the user, a stylesheet including a notice on the maintenance in a noticeable way is selected. If a presentation mode set in the device is instructed (YES at S108), a stylesheet is selected based on the presentation mode (S110). For example, when a universal design is set, a stylesheet of universal design is selected. After the stylesheet is selected, the stylesheet designation section in the XML data is edited to designate the selected stylesheet (S112). When the selection condition is set beforehand, the stylesheet can be selected automatically according to the selection condition. Alternatively, when the stylesheet selection is instructed, a graphic user interface for inputting the selection condition is displayed on the screen, and the user instructs the selection condition on the screen.

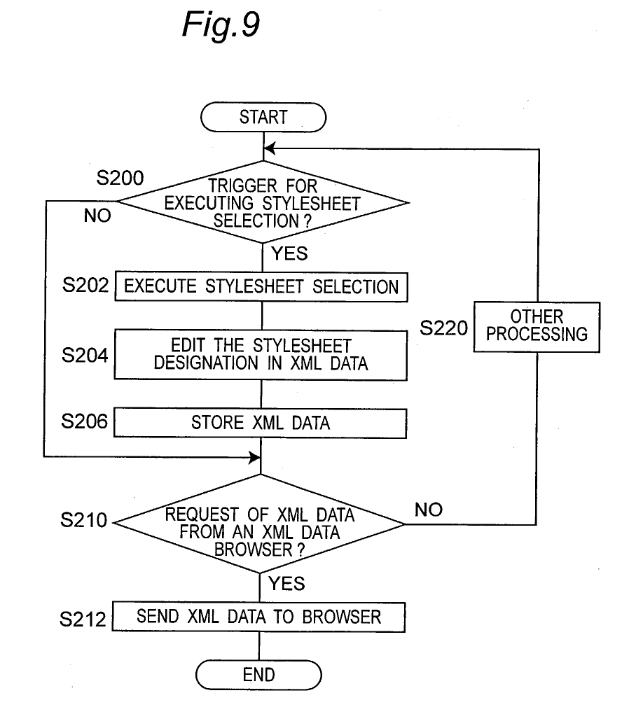

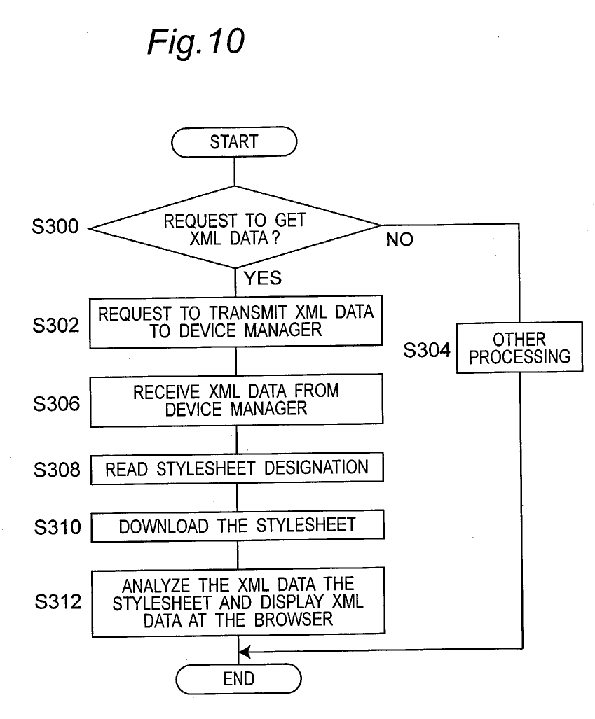

FIGS. 9 and 10 show processing in the device manager 300 and in the client terminal 400, respectively. In the client terminal 400, a user activates a web browser 422 supporting XML for browsing data management information and inputs the URI of the device manager 300. As shown in FIG. 10, if the web browser 422 accepts the user's input of a request of device management data (YES at S300), it sends a request of device management data to the device manager 300 (S302). If the user's input is not the request of device management data (NO at S300), a processing for the input is performed (S304).

In the device manager 300, the device management program 320 acquires management data from the devices to be managed and makes XML data describing the device management data, for example, periodically and stores the XML data in the XML data storage portion 324. As shown in FIG. 9, in the device management program 320, when a trigger happens for execution of the stylesheet selection (S200), the stylesheet selector 426 (FIG. 8) is activated to perform the stylesheet selection (S202). The trigger is, for example, a request of device management data from the web browser in a terminal 400. When a stylesheet is selected, the selected stylesheet is correlated to the XML data. For example, the stylesheet designation in the XML data is edited (S204). Then, the edited XML data is stored in the XML data storage portion 324 (S206). When a request of management data (XML data) from a terminal 400 happens (YES at S210), the XML data in the XML data storage portion 324 is transmitted to the browser (S212).

In the terminal 400, as shown in FIG. 10, the web browser 422 receives XML data from the device manager 300 (S306). Then, the stylesheet designation in the XML data is read (S308), and a request of stylesheet is sent to the position where the stylesheet designated in the XML data is stored. Thus, the stylesheet is downloaded therefrom (S310). Then, the XML data received from the device manager 300 and the received stylesheet are analyzed by using the XML parser in the web browser, to present the XML data (S312).

Alternatively, a web browser is installed in a device 100 connected to the device manager 300, and the management data is displayed in an operational panel of the device 100. Thus, a user of the device 100 can activate the web browser in the operational panel 108 to display the device management data. The optimum stylesheet is selected according to the selection condition (for example, the status and environment of the device 100), and the XML data is displayed by using the selected stylesheet.

Alternatively, a client terminal 400 communicates through the communication device 410 to the device manager 300 to send and to receive data for determining a stylesheet. The client terminal 400 sends information on the selection of stylesheet such as information on application programs 420 in the client terminal 400 or the network 500. Then, the stylesheet selector 326 in the device manager 300 selects a stylesheet according to the information on the selection of stylesheet.

A device such as the multifunction peripheral 100 may perform the above-mentioned device management, without providing a server exclusive for device management in the network.

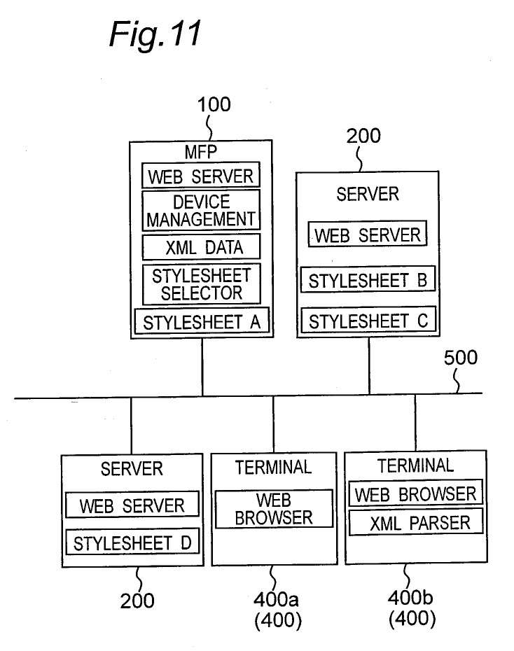

FIG. 11 shows a modified example where a multifunction peripheral 100 performs the device management. The multifunction peripheral 100 has a structure similar to that shown in FIG. 4 except that the storage device 122 stores the device management program 320, the stylesheet selector 326, the storage portion 324 for storing XML data, the storage portion 328 for storing the database for stylesheet selection, and the storage portion 330 for storing the selection condition used for selecting the stylesheet. The device management program 320 manages the multifunction peripheral 100 and other peripherals to be managed. The stylesheet selector 326 determines a stylesheet based on the selection condition and edits to correlate the XML data with the determined stylesheet.

Next, a second embodiment of the invention is explained. In this embodiment, a stylesheet selector is operated in an environment at the side of a client terminal. A stylesheet can be determined according to information at the side of a client terminal (including information on the environment).

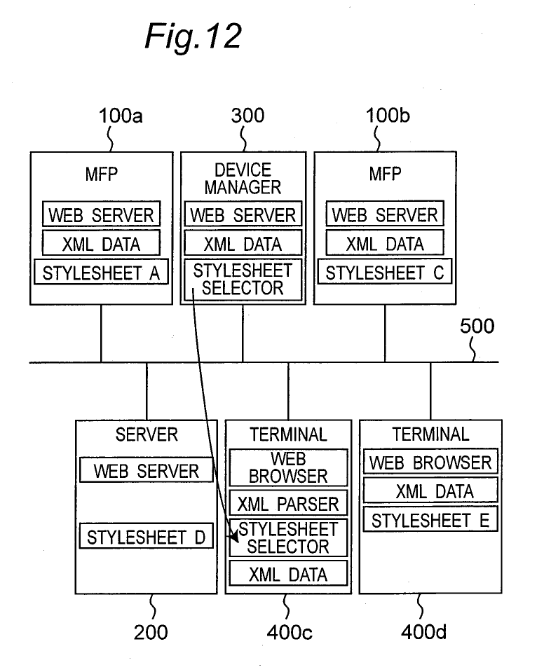

FIG. 12 shows a network environment in the second embodiment. Similarly to that in the first embodiment, shared devices 100, a server apparatus 200, a device manager 300 and client terminals 400 such as personal computers are connected to a network 500 such as a local area network or the Internet. The hardware structures of the devices are similar to the counterparts in the first embodiment, and the explanation thereon is omitted here. In the example shown in FIG. 12, the terminals 400 include terminals 400c and 400d. In contrast to the first embodiment, the stylesheet selection is performed in the client terminal 400c.

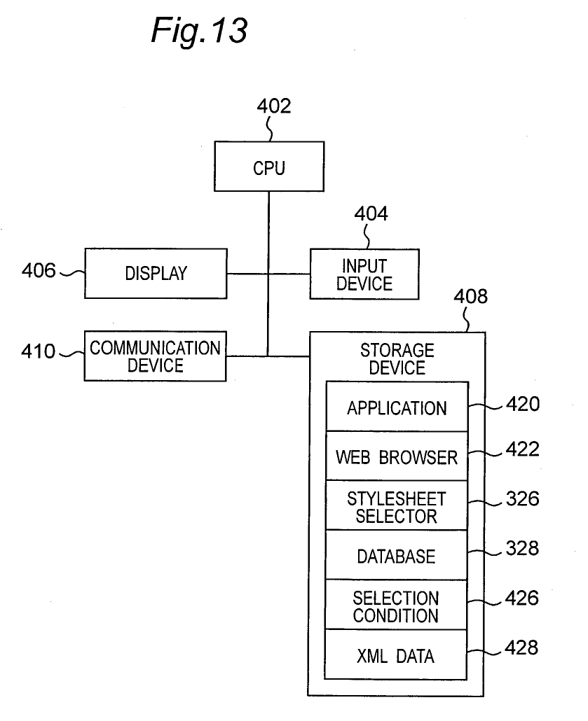

FIG. 13 shows the client terminal 400c. In order to execute the stylesheet selection, the client terminal 400c further stores a stylesheet selector 326, or an application program for selecting a stylesheet, a database 328 for the stylesheet selection in the storage device 408 and the selection condition data 426. The stylesheet selector 326 selects a stylesheet according to the selection condition with reference to the database 328. Then, the selected stylesheet is described in the stylesheet designation portion in the XML data 428 received from the device manager 300. A stylesheet is not necessarily stored in the terminal 400c.

In the client terminal 400 explained above, if the storage device 408 is a hard disk drive, programs such as the stylesheet selector 326 is stored in a hard disk. The programs may also be stored in a medium such as a flexible disk or a compact disk if the storage device 408 is a flexible disk drive or a compact disk drive.

In the above-mentioned system, when a web browser 422 supporting XML (or an XML data browser) in a client terminal 400c requests the device management data, the stylesheet selector 326 is sent by the device manager 300 to the client terminal 400c. The stylesheet selector 326 is an application program executable in the terminal 400c. That is, the device manager 300 stores the stylesheet selector 326 in the storage device 308, and it sends the stylesheet selector 326 and the XML data to a client terminal 400c when the terminal 400c requests the device management data (XML data).

In the terminal 400c, the stylesheet selector 326 executes the stylesheet selection automatically or manually. It determines a stylesheet according to the selection condition, edits the XML data downloaded in the client terminal 400c to correlate the selected stylesheet with the XML data. For example, the XML data is edited to describe the determined stylesheet in the stylesheet designation section.

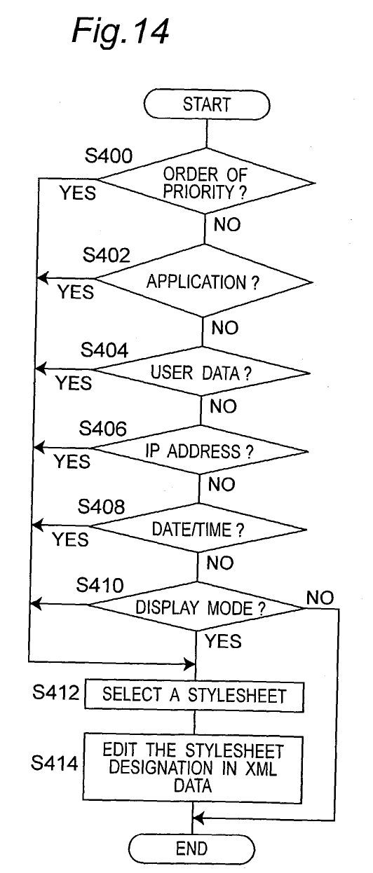

FIG. 14 is a flowchart of stylesheet selection 326 executed in the client terminal 400c. When the stylesheet selection is instructed, a stylesheet is retrieved and determined in the network based on the selection condition stored beforehand. The stylesheet selection condition in the stylesheet selector 326 may be based on the status, environment and the like of the terminal 400c. For example, it is the order of priority, application programs installed in the terminal 400c, user information in the terminal 400c, date and time, or presentation mode such as a universal design set in the web browser 422, information on the stylesheet selection obtained by communication with the device manager 300, or XML data received and analyzed by the web browser.

In the flow of the stylesheet selector shown in FIG. 14, if selection of stylesheet based on the order of priority is instructed (YES at S400), a stylesheet available in the network is retrieved, and the stylesheet having the highest priority is selected (S412). If selection based on the application programs installed in the terminal 400c is instructed (YES at S402), a stylesheet is selected according to the application programs (S412). If selection based on the user information in the terminal 400c is instructed (YES at S404), a stylesheet designated by the user is determined according to the user information (S412). In this case, the stylesheet has been designated for each user in the terminal 400c. IF selection based on Internet protocol (IP) address of the terminal 400c is instructed (YES at S406), the style sheet is selected based on the IP address (S412). In this case, when the web browser 422 is activated to access the web server 322 in the device manager 300 and a name is inputted in the log-in screen, the stylesheet is selected according to the IP address. A table of the IP address and the stylesheet is already prepared beforehand. If selection based on the date and time is instructed (YES at S408), a stylesheet is selected based on the date and time (S412). If selection based on presentation mode is instructed (YES at S410), the stylesheet is selected based on the presentation mode set in the web browser 422 (S412). For example, when a universal design is set, a stylesheet of universal design is selected. In this case, data necessary for the selection is stored beforehand in the database 328 for the stylesheet selection. If a stylesheet appropriate for the selection condition cannot be detected, a default stylesheet stored in the device manager or the like may be selected. After a stylesheet is selected, the stylesheet designation portion in the XML data is edited to designate the selected stylesheet (S414). When the selection condition is set beforehand, the stylesheet can be selected automatically according to the selection condition. Alternatively, when the stylesheet selection is instructed, a graphic user interface for inputting the selection condition is displayed on the screen, and the user instructs the selection on the screen.

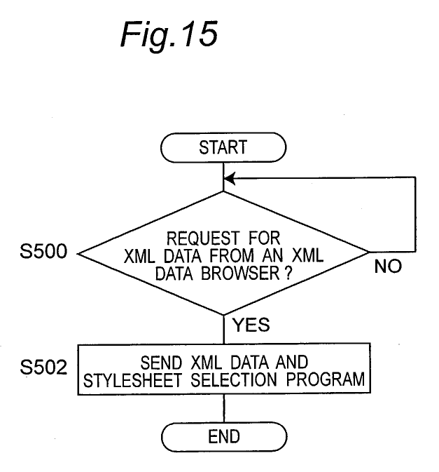

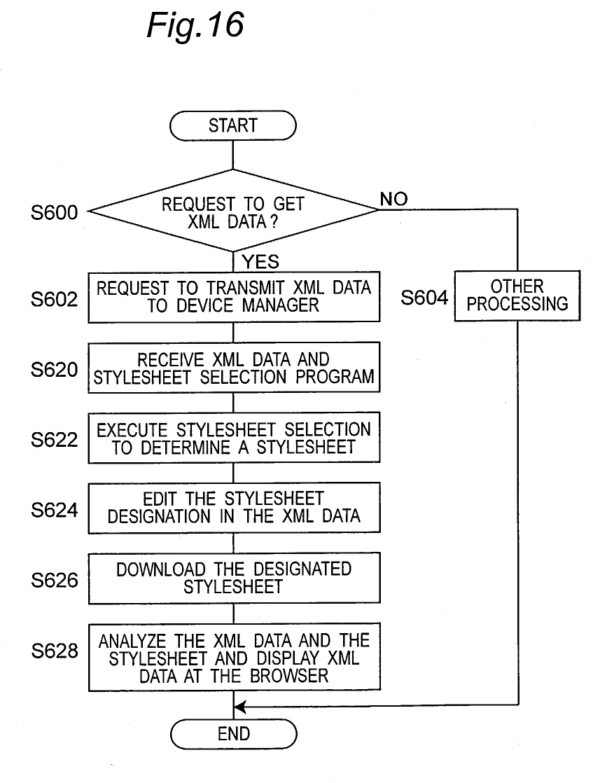

FIGS. 15 and 16 show flowcharts programs in the device manager 300 and in the client terminal 400c. In order to browse the device management data, a user at the terminal 400c uses an application program for browsing XML data (web browser) 422 to input the URI of the device manager 300 and to send a request of device management data. That is, when the web browser 422 receives a user's input of a request of transmission of XML data (YES at S600), it sends the request of XML data to the device manager (S602). If an instruction other than the request of XML data is received, a processing therefor is performed (S604).

In the storage device in the device manager 300, XML data describing the acquired device management data are made and stored. Alternatively, the device management data is made when a request from a terminal 400 is received. When a request of data management data (XML data) is received from the client terminal 400c (YES at S500), the device manager 300 sends the device management data (XML data) and the stylesheet selector 326 to the terminal 400c (S502).

In the terminal 400c, the XML data and the stylesheet selector 326 are received (S620), and the stylesheet selector 326 is activated automatically or manually for the stylesheet selection (S622). When the stylesheet selector 326 determines a stylesheet based on the stylesheet selection condition, the determined stylesheet is correlated to the XML data, for example, by editing the stylesheet designation portion in the received XML data (S624), the edited XML data is stored in the XML data storage portion. Next, a stylesheet request is transmitted to the position where the determined stylesheet is stored and the stylesheet is received (S626). Then, the received XML data and the stylesheet are analyzed, and the XML data is displayed on the screen of the display device (S628). Thus, the user at the client terminal 400c can browse or print the XML data.

Alternatively, the client terminal 400c sends and receives information on the stylesheet selection with the device manager 300 in order to select a stylesheet and determines the stylesheet according to the information. In this case, the selection condition may include the current situation of the application programs 420 in the client terminal 400c or of the network 500.

Alternatively, the device manager 300 sends only the stylesheet selector 326 when a request of XML data is received from the client terminal 400c. When the stylesheet selector 326 determines the stylesheet in the client terminal 400c, it sends a request to edit the XML data held in the device manager 300 to designate the determined stylesheet in the stylesheet designation section in the XML data. Then, the client terminal 400c downloads the edited XML data from the device manager 300 to present the XML data by the web browser. In this case, when the device management data is presented next time, it is not needed to receive the stylesheet selector 326 from the device manager 300.

In the above-mentioned embodiment, the stylesheet selector 326 is sent through the network. However, the stylesheet selector 326 may be recorded in a recording medium such as a CD-ROM or the like and is sent to the manager and the user in the terminal 400c.

Furthermore, the stylesheet selector 326 itself may have a function for browsing XML data. In this case, after the stylesheet selector 326 selects a stylesheet, the function for browsing XML data analyzes the XML data and the stylesheet to present the XML data. Similarly to the above-mentioned steps S508 to S512, the stylesheet selector 326 determines a stylesheet according to the selection condition, edits the stylesheet designation portion in the received XML data based on the determined stylesheet and stores the edited XML data in the storage device. Then, the XML data is analyzed and presented on the screen. The stylesheet selector 326 may further have functions for sending a request of the device management data and for receiving the device management data through the network.

Alternatively, the stylesheet selector 326 may be activated in the device manager 300. In this case, the stylesheet selector 326 determines a stylesheet based on the selection condition and correlates the XML data stored in the storage device in the device manager 300 with the determined stylesheet.

In the above-mentioned two embodiments, a web server is used for sending XML data, and a web browser is used for presenting the XML data. However, instead of the web server and the web browser, application programs having functions for sending and presenting XML data may be used.

In the above-mentioned embodiments, when XML data is presented, a stylesheet selector can select a stylesheet among available stylesheets automatically or manually based on the situation in a device or in a client terminal. Thus, XML data such as device management data can be presented in an appropriate layout for the device or the client terminal.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A device manager managing a device and connectable to a client terminal through a network, the device manager comprising:
an acquisition device which acquires device management data of the device;
a storage device which stores the acquired device management data as XML data;
a selector which selects a stylesheet used to present the XML data among one or more stylesheets based on a selection condition;
an editor which correlates the stylesheet selected by said selector with the XML data; and
a data provider which provides the XML data to the client terminal in response to a request from the client terminal.

2. The device manager according to claim 1, wherein said storage device further stores the selection condition.

3. The device manager according to claim 1, wherein said selector provides a screen for accepting the selection condition inputted by a user of the client terminal.

4. The device manager according to claim 1, wherein said storage device further stores a database used for the selection of stylesheet by said selector.

5. The device manager according to claim 1, wherein the selection condition is related to at least one of status and environment of the device.

6. The device manager according to claim 1, wherein the selection condition is an order of priority determined for each stylesheet.

7. The device manager according to claim 1, wherein the selection condition is related to at least one of status and environment of the client terminal.

8. The device manager according to claim 1, wherein said selector selects the stylesheet among the one or more stylesheets stored in a server apparatus connected through the network to the device manager.

9. The device manager according to claim 1, wherein said editor describes a location of the stylesheet selected by said selector and a file name thereof in the XML data.

10. A computer-readable storage medium storing a program comprising the steps of:
making XML data based on device management data of a device in which the program is installed;
selecting a stylesheet for presenting the XML data among one or more stylesheets based on a selection condition;
editing the XML data to correlate the XML data with the selected stylesheet; and
sending the edited XML data to a client terminal connected to the device when requested by the client terminal.

11. A method of providing XML data by a device manager in a system wherein the device manager is connected through a network to a device managed by the device manager and to a client terminal, the method comprising the steps of:
receiving device management data from the device, and making XML data based on the management data;
selecting a stylesheet for presenting the XML data among one or more stylesheets based on a selection condition;
editing the XML data to correlate the XML data with the selected stylesheet; and
sending the edited XML data to the client terminal when requested by the client terminal.

12. A client terminal connectable through a network to a device manager which manages a device, the client terminal comprising:
a data presenter of XML data supporting XML, said data presenter requesting and receiving device management data as XML data through the network to and from the device manager;
a storage device which stores the received device management data as XML data;
a selector which selects a stylesheet used to present the XML data among one or more stylesheets based on a selection condition; and
an editor which correlates the stylesheet selected by said selector with the XML data to be presented by said data presenter;
whereby the data presenter presents the XML data with use of the stylesheet.

13. The client terminal according to claim 12, wherein said data presenter receives the stylesheet selector from the device manager.

14. The client terminal according to claim 12, wherein said storage device further stores the selection condition.

15. The client terminal according to claim 12, wherein said selector provides a screen for inputting the selection condition and receiving the selection condition inputted by a user.

16. The client terminal according to claim 12, wherein said storage device further stores a database used for the selection of stylesheet by said selector.

17. The client terminal according to claim 12, wherein said data presenter is a web browser.

18. The client terminal according to claim 12, wherein the selection condition is related to at least one of status and environment of the device.

19. The client terminal according to claim 12, wherein the selection condition is related to at least one of status and environment of said data presenter.

20. The client terminal according to claim 12, wherein the selection condition is an order of priority determined for each stylesheet.

21. A computer-readable storage medium storing a program comprising the steps of:
sending a request of device management data and receiving the device management data as XML data through a network;
selecting a stylesheet for the XML data among one or more stylesheets based on a selection condition;
editing the XML data to use the selected stylesheet for presenting the XML data; and
presenting the XML data with the selected stylesheet.

22. The computer-readable storage medium according to claim 21, the program further comprising the step of receiving a program of the step of selecting a stylesheet for the XML data through the network.

23. The computer-readable storage medium according to claim 21, the program further comprising the step of storing the selection condition.

24. The computer-readable storage medium according to claim 21, the program further comprising the step of providing a user interface for a user to input the selection condition.

25. The computer-readable storage medium according to claim 21, the program further comprising the step of storing a database used for the selection of stylesheet.

26. The computer-readable storage medium according to claim 21, wherein the stylesheet is selected among the one or more stylesheets stored in a server apparatus connected through the network to the device manager.

27. The computer-readable storage medium according to claim 21, wherein the XML data is edited to describe a location of the selected stylesheet and a file name thereof in the XML data.

28. A method of presenting XML data by a client terminal in a system wherein the client terminal is connected through a network to a device manager and to a device managed by the device manager, the method comprising the steps of:
sending a request of device management data to the device manager;
receiving the device management data as XML data of the device;
selecting a stylesheet for the XML data among one or more stylesheets based on a selection condition;
editing the XML data to use the selected stylesheet for presenting the XML data; and
presenting the XML data with the selected stylesheet.

29. The method according to claim 19, further comprising the step of receiving a program for the selecting step from the device manager.
